(19) United States
(12) Patent Application Publication
(10) Pub. No.: US 2017/0197731 A1
(43) Pub. Date: Jul. 13, 2017

(54) METHOD AND APPARATUS FOR HAND LAUNCHING UNMANNED AERIAL VEHICLE

(71) Applicant: ZEROTECH (Shenzhen) Intelligence Robot Co., Ltd., Shenzhen (CN)

(72) Inventors: Jianjun Yang, Beijing (CN); Hongtao Sun, Beijing (CN)

(21) Appl. No.: 15/090,597

(22) Filed: Apr. 4, 2016

(30) Foreign Application Priority Data
Jan. 8, 2016 (CN) 201610012266.7
Jan. 8, 2016 (CN) 201620017779.2

(51) Int. Cl. B64F 1/04; G05D 1/00; B64C 39/02

(52) U.S. Cl. CPC B64F 1/04; B64C 39/024; G05D 1/0016; B64C 2201/088; B64C 2201/108; B64C 2201/141; B64C 2201/146

(57) ABSTRACT

A method for hand launching an unmanned aerial vehicle (UAV) includes detecting a first motion state of the UAV via a sensor, and controlling the UAV to enter into a launch mode according to the detected first motion state; and detecting a second motion state of the UAV via the sensor after the UAV enters into the launch mode, and controlling whether or not to activate a flight system of the UAV according to the detected second motion state.

### CROSS REFERENCE TO RELATED APPLICATIONS

This application claims priority to Chinese Patent Application Number 201610012266.7 filed on Jan. 8, 2016, and Chinese Patent Application Number 201620017779.2 filed on Jan. 8, 2016, the entire contents of which are incorporated herein by reference.

### TECHNICAL FIELD

The present application relates to unmanned aerial vehicle (UAV) technology, and more particularly to a method and apparatus for hand launching a UAV.

### BACKGROUND

People usually operate UAVs such as multi-rotor UAVs using remote consoles. Typically, when a UAV operator wants to launch a UAV, he or she may need to place the UAV on the ground, and then operate a remote console to launch the UAV into the air. However, such a launching mode requires the UAV operator to control the altitude, speed, orientation, acceleration of the UAV and some other factors, which are critical to the normal safe launching of the UAV. Accordingly, the UAV operator may need to spend many hours of practice and training to master the launching operation of UAVs.

Certain technologies have been developed to solve the difficulty in launching UAVs by a remote console operated by people with little operation experience or skills. Chinese Patent Publication No. CN105116909A has disclosed a method for hand launching UAVs. When launching a UAV, the UAV operator may hold the UAV flatwise and then release it. The UAV may detect a change in its motion state after the release relative to when it was not released, in order to determine whether or not to launch itself automatically. Chinese Patent Publication No. CN104685436A has disclosed another UAV hand launching method. The method may recognize releasing of an UAV from the UAV operator, by detecting a change in acceleration, speed, position or orientation of the UAV, so as to launch the UAV. However, for these technologies, the UAVs may be too close to the UAV operator when it is initially launched, which leads to various safety issues. Also, it frequently happens that such UAVs are launched by unintentional operations, such as falling off from the operator's hand or other unexpected movements in operator's hand, which may cause injuries to the UAV operators as well as people around UAV.

Thus, there is a need for a method and apparatus for hand launching UAVs that can simplify the operation of UAVs and reduce safety concerns.

### SUMMARY

An objective of the present application is to provide a method and apparatus for hand launching unmanned aerial vehicle (UAV) that can simplify the operation of UAVs.

Another objective of the present application is to reduce safety concerns during the launching process of UAVs.

To address at least one of the above objectives, in a first aspect of the present application, there is disclosed a method for hand launching a UAV. The method includes detecting a first motion state of the UAV via a sensor, and controlling the UAV to enter into a launch mode according to the detected first motion state; and detecting a second motion state of the UAV via a sensor after the UAV enters into the launch mode, and controlling whether or not to activate a flight system of the UAV according to the detected second motion state.

In another aspect of the present application, there is disclosed an apparatus for hand launching a UAV. The apparatus includes a sensor configured to detect motion states of the UAV; and a launch control unit configured to control the UAV to enter into a launch mode according to a first motion state of the UAV detected via the sensor, and control whether or not to activate a flight system of the UAV according to a second motion state detected via the sensor after the UAV enters into the launch mode.

In a further aspect of the present application, there is disclosed a UAV having a processor and a non-transitory storage medium having stored therein instructions that, when executed by the processor, causes the UAV to perform: detecting a first motion state of the UAV via a sensor, and controlling the UAV to enter into a launch mode according to the detected first motion state; and detecting a second motion state of the UAV via a sensor after the UAV enters into the launch mode, and controlling whether or not to activate a flight system of the UAV according to the detected second motion state.

The foregoing has outlined, rather broadly, features of the present application. Additional features of the present application will be described, hereinafter, which form the subject of the claims of the present application. It should be appreciated by those skilled in the art that the conception and specific embodiments disclosed herein may be readily utilized as a basis for modifying or designing other structures or processes for carrying out the objectives of the present application. It should also be realized by those skilled in the art that such equivalent constructions do not depart from the spirit and scope of the present application as set forth in the appended claims.

### BRIEF DESCRIPTION OF THE DRAWINGS

The aforementioned features and other features of the present application will be further described in the following paragraphs by referring to the accompanying drawings and the appended claims. It will be understood that, these accompanying drawings merely illustrate certain embodiments in accordance with the present application and should not be considered as limitation to the scope of the present application. Unless otherwise specified, the accompanying drawings need not be proportional, and similar reference characters generally denote similar elements.

FIG. 1 shows an exemplary UAV according to an embodiment of the present application.

FIG. 2 shows a block diagram of the UAV shown in FIG. 1.

FIG. 3 shows a flow chart of a method for hand launching a UAV according to an embodiment of the present application.

FIG. 4 shows a process that a UAV is thrown into the air according to an embodiment of the present application.

FIG. 5 shows a flow chart of a method for hand launching a UAV according to an embodiment of the present application.

FIG. 6 shows a flow chart of a method for hand launching a UAV according to an exemplary embodiment of the present application.

### DETAILED DESCRIPTION OF THE PREFERRED EMBODIMENTS

The following detailed description refers to the accompanying drawings as a part of the present application. Unless otherwise stated in the context, similar symbols generally represent similar components in the accompanying figures. The illustrative embodiments described in the detailed description, the accompanying drawings and the claims are not limiting, and other embodiments may be adopted, or modifications may be made without deviating from the spirit and subject of the present application. It should be understood that, the various aspects of the present application described and graphically presented herein may be arranged, replaced, combined, divided and designed in many different configurations, and these different configurations are implicitly included in the present application.

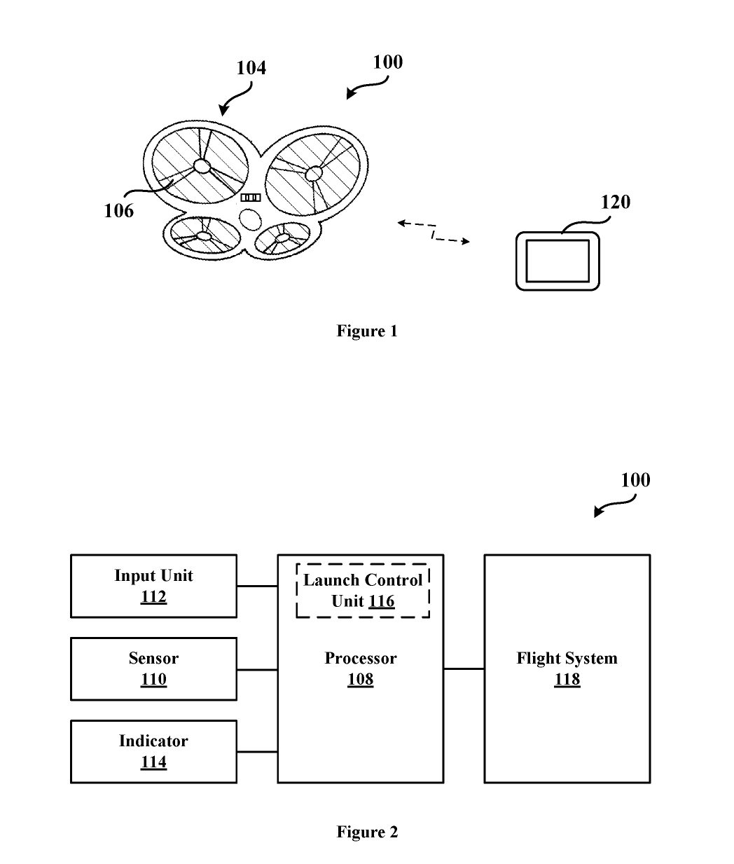

FIG. 1 shows an exemplary UAV 100 according to an embodiment of the present application. As shown in FIG. 1, the UAV 100 is an unmanned drone of a small dimension, such as a four-disc UAV.

As shown in FIG. 1, the UAV 100 has one or more rotors 104 that drive the movement of the UAV, and discs 106 of the rotors 104 control the lift and torque of the UAV, thereby moving the UAV 100 in a desired direction and at a desired speed. The rotors 104 and the discs 106 are parts of a flight system of the UAV 100, and the flight system may include other flight-related components such as a piloting unit that pilots the flight of the UAV 100. The UAV 100 may be in wireless communication with a remote console 120, which may be operated by a UAV operator. With the remote console 120, the UAV operator may give various control instructions to control the flight and other actions of the UAV 100.

FIG. 2 shows a block diagram of the UAV 100 shown in FIG. 1.

As shown in FIG. 2, the UAV 100 has a processor 108 which is electrically coupled to the flight system 118. The processor 108 is used to control the movement of the UAV 100, for example, either in an automatic manner or responsive to flight control instructions provided by the UAV operator.

The UAV 100 further has a sensor 110 which is used to detect the motion of the UAV 100. For example, the sensor 110 may include one or more motion sensors such as an accelerometer, a velocity meter, an ultrasound transducer, an infrared sensor, an optical sensor, a radio-frequency system, a gyro sensor, a camera, a multi-antenna system or any other suitable motion detecting components. In certain embodiments, the sensor 110 may be a combination of various types of the foregoing motion sensors. The sensor 110 can detect at least one motion parameter of the UAV 100. The motion parameters of the UAV 100 may include, without limitation, a position, velocity, speed, acceleration or orientation of the UAV 100, or a change in position, velocity, speed, acceleration or orientation of the UAV 100. Further, the basic motion parameters of the UAV 100 may be further processed by the processor 108 or any other signal or data processing components in order to obtain more advanced motion information. For example, the processor 108 may calculate the speed, velocity or position of the UAV 100 using the detected acceleration of the UAV 100 over a period of time, or vice versa.

In the embodiment shown in FIG. 2, the sensor 110 and the processor 108 are carried on the UAV 100. Alternatively, one or both of the sensor 110 and the processor 108 may be disposed on the remote console 120 shown in FIG. 1, or may be separately disposed on the UAV 100 and the remote console 120. For example, the sensor disposed on the remote console 120 may be a camera, an ultrasound transducer or the like, which is capable of detecting the motion of the UAV 100 from the outside of the UAV 100.

In the following, the present application will be exemplarily described with reference to the embodiment in FIG. 2 where the sensor and processor are disposed on the UAV 100. It will be readily appreciated by people skilled in the art that the operation of the UAVs are similar for embodiments where the sensor and processor are disposed on the remote console.

Still referring to FIG. 2, the UAV 100 may further include an input unit 112 for receiving user inputs. The particulars of the input unit will be described in the following paragraphs.

The UAV 100 may further include an indicator 114 for presenting a prompt signal or other warning signals. For example, the indicator 114 may be an LED indicator capable of emitting the prompt and warning signals in visible form, i.e. an optical signal such as a warning light, image or text. Alternatively, the indicator 114 may be a beeper or a speaker which is capable of emitting the warning signals in audible form, i.e. an acoustic signal such as a warning sound or speech. The visible signal or the audible signal may be generated by the processor 108, which may be used to indicate working status of the UAV 100. In certain examples, the prompt or warning signals may be electronic signals which can be transmitted from the UAV 100 to the remote console and presented to the UAV operator via a display or speaker of the remote console, and accordingly, the UAV operator operating the remote console or people around the UAV may be aware of such prompt or warning signals.

The UAV 100 further includes a timer (not shown) for recording various time periods under different control modes of the processor 108.

Moreover, the UAV 100 also includes a launch control unit 116, which is used to control the launching the UAV 100. In the embodiment shown in FIG. 2, the launch control unit 116 is integrated within the processor 108, and in an alternative embodiment, the launch control unit 116 may be a separate component from the processor 108, or be disposed on the remote console.

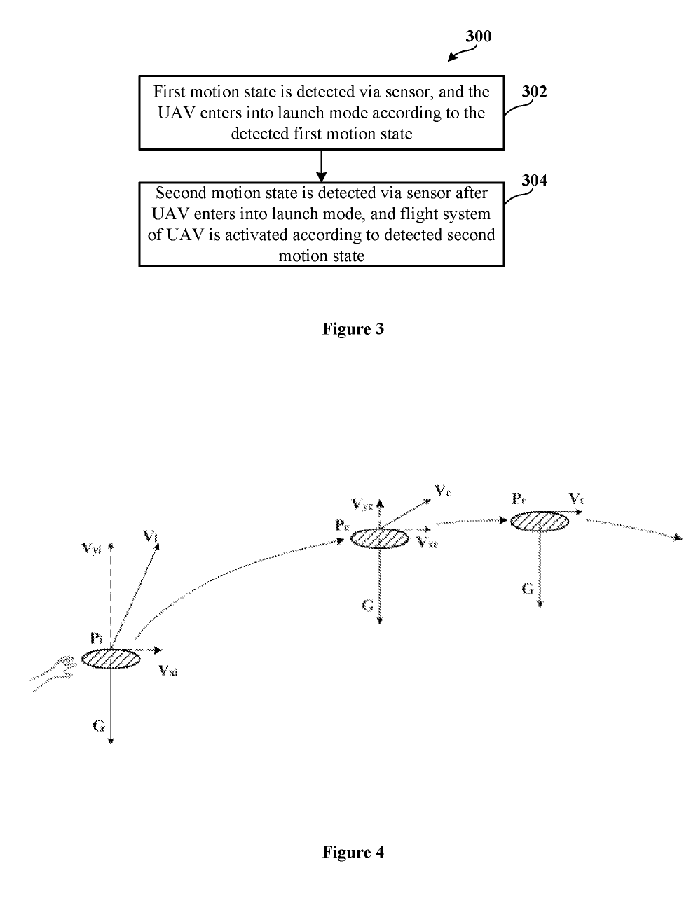

FIG. 3 shows a flow chart of a method 300 for hand launching a UAV such as the UAV 100 shown in FIGS. 1 and 2, according to an embodiment of the present application. The method may be implemented by the launching control unit 116, the sensor 110, the processor 108 and other components of the UAV shown in FIGS. 1 and 2.

As shown in FIG. 3, in step 302, a first motion state of the UAV is detected via a (or more) sensor(s), and the UAV is controlled to enter into a launch mode according to the detected first motion state.

Specifically, the first motion state is a motion state given by the UAV operator's releasing the UAV. The first motion state may include certain motion parameters of the UAV, for example, an acceleration of the UAV and an initial vertical speed of the UAV when it is released. These motion parameters can reflect accurately the motion state of the UAV. In particular, if the detected acceleration of the UAV is substantially equal to gravitational acceleration, it implies that there is no other forces imposing on the UAV rather than gravity. As a result, it can be deduced that the UAV is released by the UAV operator.

The detected initial vertical speed may be a vertical component of an initial velocity of the UAV, i.e. the velocity when the UAV is just released/thrown up by the UAV operator. In practice, the acceleration process of the UAV before it is released by the UAV operator may be detected using a three-axis accelerometer, and such acceleration process may be further processed to acquire the initial velocity and its vertical and/or horizontal components. The initial vertical speed of the UAV may be used to determine whether the UAV is released by the UAV operator intentionally, for example, for the launching purpose. An initial vertical speed of a small value, for example, smaller than 2 m/s, may indicate that the releasing of the UAV is accidental and not for launching purpose. For example, when the UAV falls free off the hand of the UAV operator, or when the UAV is swayed by the UAV operator, it may have a relative small initial vertical speed.

Accordingly, in a preferred embodiment, the acceleration and the initial vertical speed of the UAV is detected via the sensor(s), and then a launch control unit of the UAV may compare these parameters with respective predetermined reference values, to determine whether or not to control the UAV to enter into the launch mode. If the detected acceleration of the UAV is substantially equal to gravitational acceleration and the detected initial vertical speed of the UAV is equal to or greater than a threshold speed, then the UAV may enter into the launch mode. However, if the detected acceleration of the UAV is not substantially equal to gravitational acceleration, and/or the detected initial vertical speed of the UAV is smaller than the threshold speed, the UAV would not enter into the launch mode. It should be noted that, the acceleration substantially equal to gravitational acceleration may include, for example, an acceleration within a range [0.9 g, 1.1 g], which may be regarded as an acceptable approximate range of the gravitational acceleration g in practice. Furthermore, the threshold speed for comparison with the initial vertical speed may be greater than 3 m/s, for example, 5 m/s, 7 m/s, 10 m/s or greater than 10 m/s, so as to give a safe distance for the UAV operator. Preferably, the direction for comparing the vertical speed of the UAV with the threshold speed is an upward vertical direction. In other words, if the UAV is thrown down by the UAV operator, the UAV may not enter into the launch mode for further responses.

In certain alternative embodiments, the detected first motion state may further include other motion parameters. For example, the detected first motion state may include a ratio between the vertical speed and the horizontal speed of the initial velocity, or an inclination angle of the UAV when it is released. Such parameters may be used to determine horizontal movement of the UAV. In certain situations, the UAV's horizontal movement/speed has safety implications as well.

After the UAV enters into the launch mode, in step 304, a second motion state of the UAV is detected via the sensor, and the UAV is controlled to activate its flight system according to the detected second motion state.

When the UAV just enters into the launch mode, its flight system may still not be activated because the UAV may move not so far away from the UAV operator. In order to avoid injuries to the UAV operator or other people near the UAV, the UAV monitors in real time its motion state after it enters into the launch mode, i.e. monitors the second motion state. In certain embodiments, the UAV may detect in real time its acceleration and current vertical speed as the second motion state. Furthermore, the UAV may compare its second motion state with a predetermined condition, thereby determining whether or not to activate its flight system.

Particularly, the UAV may compare its acceleration with gravitational acceleration to determine whether it is being imposed with forces other than gravity, and compare its current vertical speed with a startup speed to determine whether it slows down enough and moves far away enough from people nearby. Preferably, the direction of both the UAV's current vertical speed and the startup speed is an upward vertical direction. In other words, when moving upward in the air, the UAV may have a current vertical speed of a positive value. Moreover, a current vertical speed of a negative value may refer to that the movement of the UAV is in a downward direction (either tiltedly or vertically), i.e. the UAV is falling down. If the acceleration of the UAV is substantially equal to gravitational acceleration and the current vertical speed is equal to or less than the startup speed, the flight system of the UAV may be activated to generate a lift for the UAV. For example, an activation signal of enabling rotation of a rotor assembly of the UAV may be transmitted from the launch control unit to the rotor assembly to generate the lift for the UAV. On the contrary, if the acceleration of the UAV is not substantially equal to gravitational acceleration and/or the current vertical speed is greater than the startup speed, the flight system of the UAV may be kept deactivated.

The startup speed is smaller than the threshold speed for comparison with the initial vertical speed of the UAV. For example, the startup speed may be 5 to 50 percent of the threshold speed. In some preferred examples, the startup speed may be smaller than 0.5 m/s, for example, 0.4 m/s, 0.3 m/s, 0.2 m/s or zero. In some other examples, the startup speed may be defined according to the initial vertical speed of the UAV, for example, less than ⅙ of the initial vertical speed. For example, the initial vertical speed of the UAV may be recorded by the UAV in order to calculate the startup speed.

It should be noted that, once the flight system of the UAV has been activated, in order to maintain the UAV flying in the air, the flight system may not be deactivated automatically by the UAV however the acceleration and current vertical speed of the UAV is. Under such condition, the flight system of the UAV may only be deactivated in response to a user control instruction of deactivating the flight system, for example, a landing instruction.

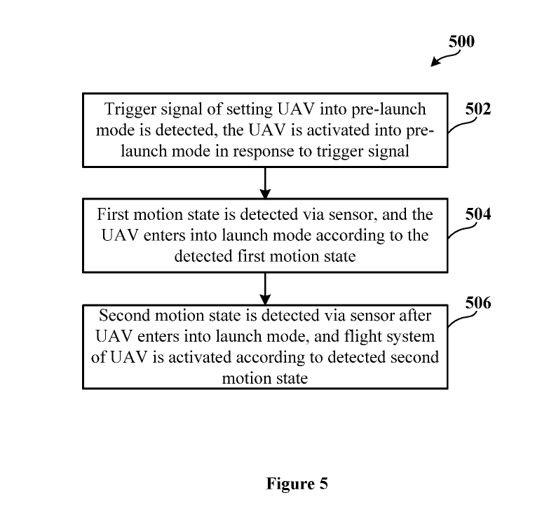

FIG. 4 shows a process that the UAV is thrown into the air according to an embodiment of the present application.

As shown in FIG. 4, at a first position Pᵢ, the UAV is released by the UAV operator and thrown into the air tiltedly and upwardly. At this time, the UAV has an initial speed Vᵢ with a vertical component V_{yi} and a horizontal component Vₓᵢ. If the air resistance is not taken into account in the process, the horizontal component V_{d} of the UAV may be substantially constant. Afterwards, the UAV follows a parabolic trajectory and moves from the first position Pᵢ to a second position P_{c}. When moving from the first position Pᵢ to the second position P_{c}, the UAV is only subject to gravitational force G, which decreases the vertical speed of the UAV from the initial value V_{yi} to V_{yc}. The horizontal speed of the UAV does not change, i.e. V_{xc} is equal to Vₓᵢ. After passing the second position P_{c}, the UAV continues to move to a third position Pₜ where its vertical speed further decreases to zero, i.e. the third position Pₜ is the highest position of the UAV during the process. After passing the third position Pₜ, the UAV may fall down towards the ground.

As can be seen from FIG. 4, if the UAV moves past the second position P_{c} of the parabolic trajectory, the UAV may be far away from the UAV operator. It is much safer if the UAV can be launched at this time or a short period later. Accordingly, the flight system of the UAV, including the rotors and the piloting unit, is activated to launch the UAV. Afterwards, the UAV can fly in the air under the control of the UAV operator.

From the foregoing, the UAV can be launched automatically by comparing its motion states with predetermined conditions, thereby not requiring the UAV operator to perform complicated operations to the UAV. Thus, the operation of the UAV can be significantly simplified and it is much easier for people to master the operation of the UAV. Moreover, the UAV can only be launched after it has experienced two motion states, which reduces the possibility that the UAV is launched due to accidental releasing by the UAV operators, as well as improving the safety of operating the UAV.

FIG. 5 shows another method for hand launching a UAV according to an embodiment of the present application.

As shown in FIG. 5, in step 502, a trigger signal of setting the UAV into a pre-launch mode is detected, and then the UAV is activated into the pre-launch mode in response to the trigger signal.

Specifically, the pre-launch mode is an operation mode where certain components of the UAV are activated or enabled to be ready for a launching action of the UAV. For example, when the UAV is in the pre-launch mode, its processor and sensor are turned on. However, certain other components of the UAV may not be activated yet in the pre-launch mode. For example, a flight system of the UAV may not be activated in the pre-launch mode.

The trigger signal may be generated by a sensible user action, such as a hand action. For example, the hand action may include two or more consecutive tap actions on the UAV, for example, at a particular position or at any position of a housing of the UAV. The tap actions may be detected by an input unit of the UAV. For example, the input unit may be a physical button or a touch sensing pad. In an alternative example, the hand action may also be detected by the sensor of the UAV, for example, by an accelerometer carried on the UAV. In other words, the sensor functions as the input unit for receiving or detecting the hand action. Particularly, the hand action on the UAV may produce small pulses of acceleration to the UAV, which can be sensed by the sensor carried on the UAV. The sensible pulses of acceleration may be of an amplitude greater than 1 g (i.e. gravitational acceleration which is 9.8 m/s²), or preferably greater than 2.5 g. Preferably, in order to avoid undesired signals caused by misconduct of the UAV operator, it is desirable that the hand action be performed twice or more in a short period, i.e., in a time period less than 3 seconds, or preferably, in a time period ranging from 1 second to 3 seconds. If the two or more hand actions on the UAV are not applied to the UAV within such time period, the UAV will not enter into the pre-launch mode. In a preferred embodiment, the hand action may include three consecutive tap actions. In another alternative example, the trigger signal may be generated by operation on a trigger switch of the UAV, and said trigger switch functions as a part of the input unit. For example, the trigger switch may have two positions which correspond to two respective states of the UAV. A first position of the trigger switch may correspond to the pre-launch ON mode the UAV, and a second position of the trigger switch may correspond to the pre-launch OFF mode. The UAV operator may switch the trigger switch between its two positions to control the working of the UAV.

If the trigger signal has been received, the UAV may enter into the pre-launch mode, otherwise the UAV may not enter into the pre-launch mode. When the UAV is in the pre-launch mode, a prompt signal for notifying that the UAV is in the pre-launch mode may be generated. Accordingly, an indicator of the UAV may be activated to present such prompt signal to the UAV operator. For example, an LED indicator may display warning lights, images, texts or symbols to the UAV operator, or a beeper or speaker may emit warning sounds to the UAV operator or people around. Alternatively, the prompt signal may be generated as an electronic signal which can be transmitted to the remote console. In this way, the UAV operator and/or people around may be notified to avoid unintentional damages or injuries.

In some embodiments, the UAV may not exit the pre-launch mode until an external control instruction from the UAV operator is received. In other embodiments, the UAV may remain in the pre-launch mode for a time period and then automatically exit the pre-launch mode. For example, the UAV may include a timer for recording a pre-launch time after the UAV has been activated into the pre-launch mode. Furthermore, the processor may be further configured to deactivate the UAV out of the pre-launch mode after the pre-launch time exceeds a predetermined time threshold such as 5 to 10 seconds, if the flight system of the UAV is not activated. The predetermined time threshold may be configurable depending on the physical condition of the UAV operator. For example, the predetermined time threshold may be 7 seconds for a middle-aged person, and 10 seconds or longer for children or aged people. The timer may be implemented with a timing program within the processor based on an internal clock or crystal oscillator.

When the UAV is in the pre-launch mode, the motion state of the UAV is detected by the sensor. As described above, when the UAV is in the pre-launch mode, certain components of the UAV, such as the sensor and the processor, are activated. In this way, the UAV is ready to respond to the subsequent operations performed to the UAV by the UAV operator.

In step 504, when the UAV has been activated in the pre-launch mode, a first motion state of the UAV is detected via the sensor of the UAV, and the UAV is controlled to enter into a launch mode according to the detected first motion state. Furthermore, in step 506, a second motion state of the UAV is detected via the sensor, and the UAV is controlled to activate its flight system according to the detected second motion state. Afterwards, the UAV may be launched accordingly.

It can be seen that, before being launched, the UAV is firstly activated into the pre-launch mode where the flight system is not activated. This gives the UAV operator more time to prepare for the launching of the UAV, thereby avoiding undesired safety concerns to the UAV operator or the others.

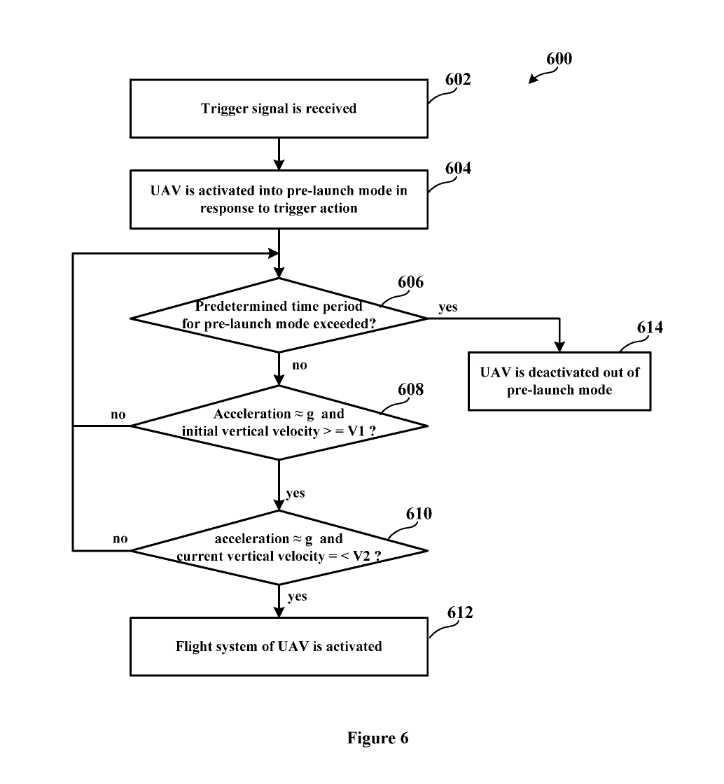

FIG. 6 shows a flow chart of a method for hand launching a UAV according to an exemplary embodiment of the present application.

As shown in FIG. 6, the process of the method 600 starts from step 602. In step 602, a trigger signal of setting the UAV into a pre-launch mode is detected by the UAV. In step 604, the UAV is activated into the pre-launch mode in response to the trigger signal. In step 606, the UAV may record a pre-launch time after it has been activated into the pre-launch mode, and compare the pre-launch time with a predetermined time period. If the pre-launch time exceeds the predetermined time period for the pre-launch mode, then the process goes to step 608. In step 608, a first motion state of the UAV is detected, for example, by one or more sensors carried on the UAV, to obtain one or more motion parameters such as an acceleration and a vertical speed of the UAV. Next, the UAV may compare the detected acceleration with the gravitational acceleration g to determine whether it has been released by a UAV operator, thereby determining whether or not to enter into a launch mode. Preferably, it further compares an initial vertical speed of the UAV with a threshold speed V1. If it is determined that the detected acceleration of the UAV is substantially equal to the gravitational acceleration g and that the initial vertical speed of the UAV is equal to or greater than the threshold speed V1, then the UAV enters into the launch mode and the process goes to step 610. Otherwise, the process goes to step 606 again. In step 610, the UAV may detect its second motion state, which may include the acceleration and a current vertical speed of the UAV when it is in the launch mode. The UAV further compares its current vertical speed with a startup speed which is smaller than the initial vertical speed. If it is detected that the current vertical speed of the UAV becomes equal to or smaller than the startup speed, a flight system of the UAV may be activated to launch the UAV. Otherwise, the process may go to step 606 again. Moreover, if the pre-launch time exceeds the predetermined time threshold, the process may go to step 614, the UAV is deactivated out of the pre-launch mode and then the process is finished.

During the whole process shown in FIG. 6, it is preferred to keep monitoring the acceleration of the UAV, so as to decide if there is other force, except the gravity, acting on the UAV. In this way, under some special situations such as when the released UAV is caught by the UAV operator or when the released UAV hits an obstacle such as a wall, the launching process will be stopped and the UAV will not be launched. This provides additional safety measures for such situations to reduce accidental damages or injuries.

The embodiments of the present application may be implemented by hardware, software or any combination thereof. The hardware may be implemented by specific logic circuits, and the software may be stored in a memory and executed by appropriate instruction executing systems. For example, the software may be executed by a microprocessor or a specifically designed hardware. Those skilled in the art may understand that the previous method of the present application may be implemented by computer-executable instructions and/or control codes contained in the processor. For example, such codes may be provided in storage mediums such as hard disks, programmable memories such as ROM(s), or data mediums such as optical or electrical signal mediums.

Those skilled in the art may understand and implement other variations to the disclosed embodiments from a study of the drawings, the present application, and the appended claims. In the claims, the word “comprising” does not exclude other elements or steps, and the indefinite article “a” or “an” does not exclude a plurality. In applications according to present application, one element may perform functions of several technical feature recited in claims. Any reference signs in the claims should not be construed as limiting the scope. The scope and spirit of the present application is defined by the appended claims.

What is claimed is:

1. A method for hand launching an unmanned aerial vehicle (UAV), comprising:
detecting a first motion state of the UAV via a sensor, and controlling the UAV to enter into a launch mode according to the detected first motion state;
detecting a second motion state of the UAV via a sensor after the UAV enters into the launch mode, and controlling whether or not to activate a flight system of the UAV according to the detected second motion state.

2. The method of claim 1, wherein the first motion state comprises an acceleration and an initial vertical speed of the UAV.

3. The method of claim 2, wherein the step of detecting a first motion state of the UAV via a sensor, and controlling the UAV to enter a launch mode according to the detected first motion state comprises:
detecting the acceleration and initial vertical speed of the UAV; and
controlling the UAV to enter into the launch mode if the detected acceleration of the UAV is substantially equal to gravitational acceleration and the detected initial vertical speed of the UAV is equal to or greater than a threshold speed.

4. The method of claim 3, wherein the threshold speed is 3 m/s.

5. The method of claim 2, wherein the initial vertical speed of the UAV is given by an operator releasing the UAV.

6. The method of claim 1, wherein the second motion state comprises an acceleration of the UAV and a current vertical speed of the UAV.

7. The method of claim 6, wherein the step of detecting a second motion state of the UAV via the sensor after the UAV enters into the launch mode, and controlling whether or not to activate a flight system of the UAV according to the detected second motion state comprises:
detecting the acceleration and current vertical speed of the UAV via the sensor after the UAV enters into the launch mode, and
activating the flight system of the UAV if the acceleration of the UAV is substantially equal to gravitational acceleration and the current vertical speed of the UAV is equal to or less than a startup speed.

8. The method of claim 7, wherein the startup speed is equal to zero or less than ⅙ of the initial vertical speed of the UAV.

9. The method of claim 1, wherein activating the flight system of the UAV comprises transmitting to a rotor assembly of the flight system of the UAV an activation signal of enabling rotation of the rotor assembly to generate a lift for the UAV.

10. The method of claim 1, further comprising:
detecting a trigger signal of setting the UAV into a pre-launch mode, and activating the UAV into the pre-launch mode in response to the trigger signal; and
when the UAV is in the pre-launch mode, performing the step of detecting a first motion state of the UAV via a sensor, and controlling the UAV to enter into a launch mode according to the detected first motion state.

11. The method of claim 10, further comprising:
recording a pre-launch time after the UAV has been activated into the pre-launch mode; and
deactivating the UAV out of the pre-launch mode after the pre-launch time exceeds a predetermined time threshold, if the flight system of the UAV is not activated.

12. The method of claim 11, wherein the predetermined time threshold ranges from 5 to 10 seconds.

13. The method of claim 10, wherein the trigger signal is generated by a hand action within a predetermined time period or an operation on a trigger switch.

14. The method of claim 13, wherein the predetermined time period ranges from 1 to 3 seconds.

15. The method of claim 10, further comprising:
generating and presenting a prompt signal for notifying an operator when the UAV is in the pre-launch mode.

16. The method of claim 15, wherein the prompt signal comprises at least one of an optical signal, an acoustic signal and an electronic signal.

17. A method for hand launching a UAV, comprising:
detecting a trigger signal of setting the UAV into a pre-launch mode, activating the UAV into the pre-launch mode in response to the trigger signal, and generating and presenting a prompt signal for notifying an operator when the UAV is in the pre-launch mode;
detecting via a sensor an acceleration and an initial vertical speed of the UAV given by an operator's releasing the UAV, after the UAV has been activated into the pre-launch mode; and controlling the UAV to enter into a launch mode if the detected acceleration of the UAV is substantially equal to gravitational acceleration and the detected initial vertical speed of the UAV is equal to or greater than a threshold speed;
detecting via the sensor the acceleration and a current vertical speed of the UAV after the UAV enters into the launch mode, and enabling rotation of a rotor assembly of a flight system of the UAV to generate a lift for the UAV if the acceleration of the UAV is substantially equal to gravitational acceleration and the current vertical speed of the UAV is equal to or less than a startup speed;
wherein the trigger signal is generated by a hand action of the operator;
wherein the prompt signal comprises at least one of an optical signal, an acoustic signal and an electronic signal; and
wherein the startup speed is equal to zero or less than ⅙ of the initial vertical speed of the UAV.

18. An apparatus for hand launching an UAV, comprising:
a sensor, configured to detect motion states of the UAV;
a launch control unit, configured to control the UAV to enter into a launch mode according to a first motion state of the UAV detected via the sensor, and control whether or not to activate a flight system of the UAV according to a second motion state detected via the sensor after the UAV enters into the launch mode.

19. The apparatus of claim 18, wherein the first motion state comprises an acceleration and an initial vertical speed of the UAV.

20. The apparatus of claim 19, wherein the launch control unit is further configured to:
detect the acceleration and initial vertical speed of the UAV, and
control the UAV to enter into the launch mode if the detected acceleration of the UAV is substantially equal to gravitational acceleration and the detected initial vertical speed of the UAV is equal to or greater than a threshold speed.

21. The apparatus of claim 20, wherein the threshold speed is 3 m/s.

22. The apparatus of claim 19, wherein the initial vertical speed of the UAV is given by an operator releasing the UAV.

23. The apparatus of claim 19, wherein the second motion state comprises an acceleration of the UAV and a current vertical speed of the UAV.

24. The apparatus of claim 23, wherein the launch control unit is further configured to:
detect the acceleration and the current vertical speed of the UAV via the sensor after the UAV enters into the launch mode, and
activate the flight system of the UAV if the acceleration of the UAV is substantially equal to gravitational acceleration and the current vertical speed of the UAV is equal to or less than a startup speed.

25. The apparatus of claim 24, wherein the startup speed is equal to zero or less than ⅙ of the initial vertical speed of the UAV.

26. The apparatus of claim 18, wherein the launch control unit is further configured to:
transmit to a rotor assembly of the flight system of the UAV an activation signal of enabling rotation of the rotor assembly to generate a lift for the UAV.

27. The apparatus of claim 18, further comprising:
an input unit, configured to detect a trigger signal of setting the UAV into a pre-launch mode; and
wherein the launch control unit is further configured to:
activate the UAV into the pre-launch mode in response to the trigger signal; and
control the UAV to enter into the launch mode according to the detected first motion state when the UAV is in the pre-launch mode.

28. The apparatus of claim 27, further comprising:
a timer, configured to record a pre-launch time after the UAV has been activated into the pre-launch mode; and
wherein the launch control unit is further configured to deactivate the UAV out of the pre-launch mode after the pre-launch time exceeds a predetermined time threshold, if the flight system of the UAV is not activated.

29. The apparatus of claim 28, wherein the predetermined time threshold ranges from 5 to 10 seconds.

30. The apparatus of claim 27, wherein the trigger signal is generated by a hand action within a predetermined time period or an operation on a trigger switch.

31. The apparatus of claim 30, wherein the predetermined time period ranges from 1 to 3 seconds.

32. The apparatus of claim 27, further comprising:
an indicator, configured to present a prompt signal for notifying an operator;
wherein the launch control unit is further configured to generate the prompt signal to the indicator for notifying the operator when the UAV is in the pre-launch mode.

33. The apparatus of claim 32, wherein the prompt signal comprises at least one of an optical signal, an acoustic signal and an electronic signal.
